(19) United States
(12) Patent Application Publication
(10) Pub. No.: US 2009/0089648 A1
(43) Pub. Date: Apr. 2, 2009

(54) LOW POWER VITERBI DECODER USING SCARCE STATE TRANSITION AND PATH PRUNING

(75) Inventors: Chi Ying Tsui, Kowloon (HK); Jie Jin, New Territories (HK)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/865,643

(22) Filed: Oct. 1, 2007

(51) Int. Cl. G06F 11/10

(52) U.S. Cl. 714/795; 714/E11.032

(57) ABSTRACT

Low power Viterbi decoder techniques using Scarce State Transition (SST) and path pruning and related methods and systems are provided, which facilitate practical implementations that reduce the computational overhead and power consumption. In addition, the invention provides uneven-partitioned memory architectures for the survivor memory unit that advantageously exploits the characteristic of the maximum likelihood state probability distribution of the SST decoder facilitating further power reduction. The disclosed details enable various refinements and modifications according to decoder and system design considerations.

### TECHNICAL FIELD

The subject disclosure relates to decoding algorithms and more specifically to low power viterbi decoder techniques using scarce state transition and path pruning.

### BACKGROUND

Convolutional codes are widely used in modern digital wireless communication systems such as IEEE 802.11, IEEE 802.16 and Multi-Band (MB) Orthogonal Frequency Division Multiplexing (OFDM) Ultra-Wide-Band (UWB) systems. The Viterbi Algorithm (VA) is an optimal solution for decoding such convolutional codes. Because of the highly regular computation and storage operation, Very-Large-Scale Integration (VLSI) architecture for Viterbi decoders has been widely deployed for the channel decoder in high speed wireless systems.

Typically, conventional Viterbi decoders contain three main units: 1) a Branch Metric Unit (BMU) that can calculate the branch metrics; 2) an Add-Compare-Select Unit (ACSU) that can recursively accumulate the branch metrics as the Path Metrics (PM) makes decisions to select the most likely state transitions and generates the corresponding decision bits; and 3) a survivor memory unit (SMU) that can store the decision bits and generate the decoded output.

Among these three units, the ACSU and SMU consume most power of the decoder. In addition, the power consumption of the Viterbi decoder could account for as much as one third of the power consumption of the baseband processing. Accordingly, as demand for higher data rate wireless applications continues, power consumption in the Viterbi decoder becomes one of the most critical design challenges in implementing such a Viterbi decoder.

For example, to meet the high throughput requirement of the modem communication systems (e.g. 480 Mega bits per second (Mbps)for UWB system), a fully parallel architecture is commonly used in implementing the Viterbi decoder. As a result, in the ASCU, 2^{K-1} Add-Compare-Select (ACS) computation units are used and operating in parallel, where K is the constraint length of the convolutional code. Because many ACS units are running at a high clock frequency, the ACSU consumes a large amount of power. In addition, because of the large number of memory accesses, the SMU consumes more than half of the power of the conventional Viterbi decoder.

Some conventional methods for power reduction in the implementation of the SMU include Register Exchange (RE) and Traceback (TB). While RE generally provides an advantage of high speed, low latency, and simple control, it consumes more power than the TB mechanism, because it needs to move the data among the memories in every cycle. As a result, the TB mechanism is the most commonly used implementation for the SMU. For example, a k-pointer algorithm has been proposed for the efficient implementation of the TB-based SMU design, where the SMU is divided into several memory blocks. Simultaneous TB and decode operations are carried out in order to provide enough bandwidth for the SMU decode operation. However, power consumption suffers due to the large amount of memory access operation required, because several memory read operations are required in order to decode one bit.

Other methods that have been proposed to reduce the power consumption of the Viterbi decoder explore different aspects of the system characteristics. For example, limited search algorithms have been proposed to reduce the number of average ACS computation and the path storage required by VA. One such example is the T-algorithm, which is essentially a breadth-first decoding algorithms. Instead of computing and keeping all the 2^{K-1} states in each stage as in the traditional VA, some paths are purged according to certain criterion. Specifically, at each decoding stage, only some of the most likely paths with the cumulative path metric satisfying a certain pre-set threshold from the best path metric are retained. While a substantial amount of the ACS computation can be reduced with only minor performance degradation, implementing a parallel high-throughput T-algorithm is extremely challenging due to the serial sorting/comparison operation required to search for the best path metric at each stage. As a result, this limits such a decoders throughput.

Accordingly, further improvements are desired to increase the computational efficiency and provide the desired high-throughput, while allowing for practical implementation in the design.

The above-described deficiencies are merely intended to provide an overview of some of the problems encountered in low power viterbi decoder design, and are not intended to be exhaustive. Other problems with the state of the art may become further apparent upon review of the description of the various non-limiting embodiments of the invention that follows.

### SUMMARY

In consideration of the above-described deficiencies of the state of the art, the invention provides low power viterbi decoder techniques, related systems, and methods that are practical and reduce the computational overhead and power consumption.

According to various non-limiting embodiments, the invention provides Viterbi decoder techniques based on Scarce State Transition (SST) and path pruning. By providing techniques that seamlessly integrate path pruning techniques with the SST decoding, the techniques reduce the average (ACS) computational overhead. Advantageously, the provided techniques reduce ACS power consumption in the Viterbi decoder that are practical for implementation.

According to further non-limiting embodiments of the invention, uneven-partitioned memory architectures for the SMU are provided that advantageously exploit the characteristic of the maximum likelihood state probability distribution of the SST decoder. As a result, the provided architectures advantageously reduce the memory access during the trace back operation resulting in significant power reduction.

Additionally, various modifications are provided, which achieve a wide range of performance and computational overhead trade-offs according to system design considerations.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The low power viterbi decoder techniques using scarce state transition and path pruning and related systems and methods are further described with reference to the accompanying drawings in which:

FIG. 1 illustrates an overview of a wireless communication environment suitable for incorporation of embodiments of the present invention;

FIG. 2 depicts an exemplary non-limiting block diagram of a rate ⅓ SST decoder according to aspects of the invention;

FIGS. 3A and 3B depict the effect of different values of T on the BER performance and computation reduction according to aspects of the invention;

FIG. 4 illustrates a particular non-limiting high level methodology according to various aspects of the present invention;

FIG. 5 illustrates an exemplary non-limiting decoding apparatus suitable for performing various techniques of the present invention;

FIG. 6 illustrates an exemplary non-limiting system suitable for performing various techniques of the present invention;

FIG. 7 illustrates an exemplary non-limiting block diagram of a decoder architecture suitable for performing techniques of the invention;

FIG. 8 illustrates an exemplary non-limiting block diagram of a structure for an ACS unit in the ACSU as illustrated in FIG. 7 suitable for performing techniques of the invention;

FIG. 9 tabulates cell area for a conventional ACSU and a particular non-limiting embodiment of an ACSU according to techniques of the present invention for a 0.18 μm Complementary Metal-Oxide-Semiconductor (CMOS) process;

FIG. 10 tabulates cell area for various non-limiting embedded memory partition configurations with different bit width for a 64×64 memory unit generated by Artisan memory generator for a 0.18 μm CMOS process;

FIG. 11 depicts a distribution probability of maximum likelihood states at Signal-to-Noise Ratio (SNR)=8 Decibel (dB) for an exemplary non-limiting UWB system;

FIG. 12 depicts a distribution probability of maximum likelihood states at SNR=10 dB for an exemplary non-limiting UWB system;

FIG. 13 tabulates estimated power consumption of the traceback read operation for various non-limiting partitioning configurations, assuming power consumption of the read access is proportional to bit-width of the memory;

FIG. 14 illustrates an exemplary non-limiting block diagram of a memory unit suitable for performing techniques of the invention;

FIG. 15 depicts average read access rate of different memories of FIG. 14 with an UWB system data rate of 160 Mbps under various SNRs, according to various aspects of the invention;

FIG. 16 depicts power consumption performance of computational parts (e.g., Branch Metric Unit (BMU), Add-Compare-Select Unit (ACSU) and the additional logic for Scarce State Transition (SST) decoding) of a particular nonlimiting embodiment of a decoder according to various aspects of the present invention;

FIG. 17 depicts power consumption performance of Traceback (TB) and decoding Survivor Memory Unit (SMU) of a particular nonlimiting embodiment of a decoder according to various aspects of the present invention;

FIG. 18 depicts an overall cell area comparison of different decoding schemes for a particular nonlimiting embodiment of the invention;

FIG. 19 is a block diagram representing an exemplary non-limiting networked environment in which the present invention may be implemented;

FIG. 20 is a block diagram representing an exemplary non-limiting computing system or operating environment in which the present invention may be implemented; and

FIG. 21 illustrates an overview of a network environment suitable for service by embodiments of the invention.

### DETAILED DESCRIPTION

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the invention in a simplified form as a prelude to the more detailed description of these and various other embodiments of the invention that follow. It is understood that various modifications may be made by one skilled in the relevant art without departing from the scope of the disclosed invention. Accordingly, it is the intent to include within the scope of the invention those modifications, substitutions, and variations as may come to those skilled in the art based on the teachings herein.

In consideration of the above-described limitations, in accordance with exemplary non-limiting embodiments, the invention provides low power viterbi decoder techniques and related systems and methods that are practical and reduce the computational overhead and power consumption. For example, the invention can exploit the superior algorithmic performance of the T-algorithm, which can effectively reduce the average number of ACS and the survivor paths. However, the invention advantageously avoids the algorithm's computationally intensive serial sorting operation to find the best path metric, thus achieving a high throughput with substantial power reduction over the original search algorithm.

According to various non-limiting embodiments, the invention provides Viterbi decoder techniques based on SST and path pruning. By providing techniques that seamlessly integrate path pruning techniques with the SST decoding, the techniques reduce the average (ACS) computational overhead. Advantageously, the provided techniques reduce ACS power consumption in the Viterbi decoder that are practical for implementation. While SST was introduced to reduce the switching activities of the Viterbi decoder, it cannot reduce the average number of ACS calculations. According to exemplary non-limiting embodiments, the invention seamlessly integrates the T-algorithm and the SST together to reduce the complexity without the need of finding the best path metric at each decoding stage. As a result, the invention can provide a Viterbi decoder implementation that is small, thus making the implementation very practical.

According to further non-limiting embodiments of the invention, uneven-partitioned memory architectures for the SMU advantageously exploits the characteristic of the maximum likelihood state probability distribution of the SST decoder. As a result, the provided architectures advantageously reduce the memory access during the trace back operation resulting in significant power reduction. The invention can utilize an uneven-partitioned memory architecture for the trace-back unit of the SMU to reduce the power consumption due of SMU memory access operations.

According to a particular nonlimiting embodiment, the invention provides techniques can be used to provide the decoder in Multi-band OFDM Alliance (MBOA) UWB systems.

### DETAILED DESCRIPTION

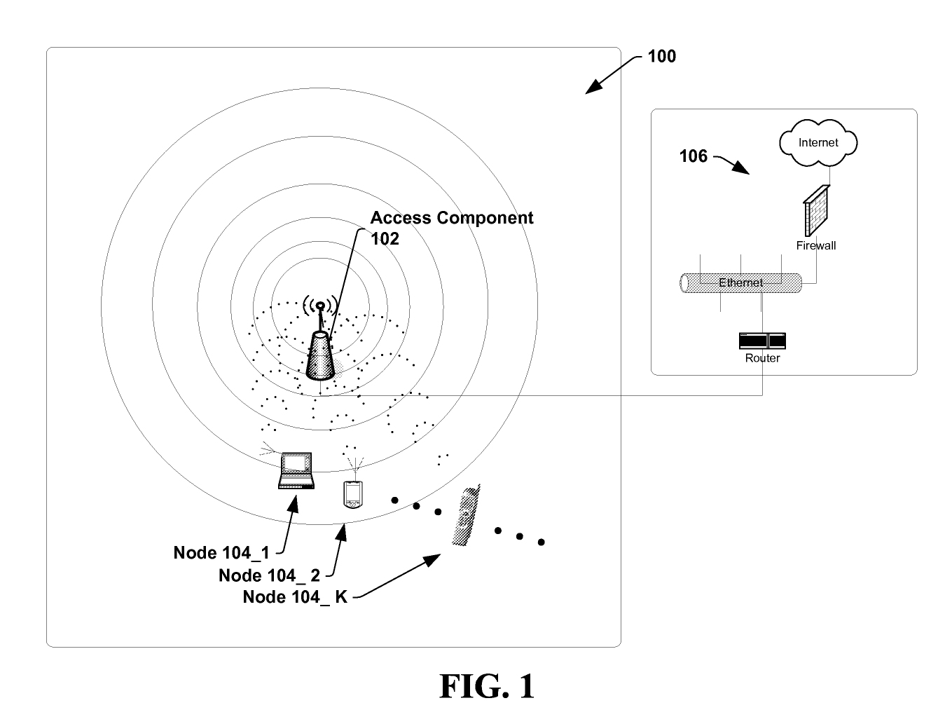

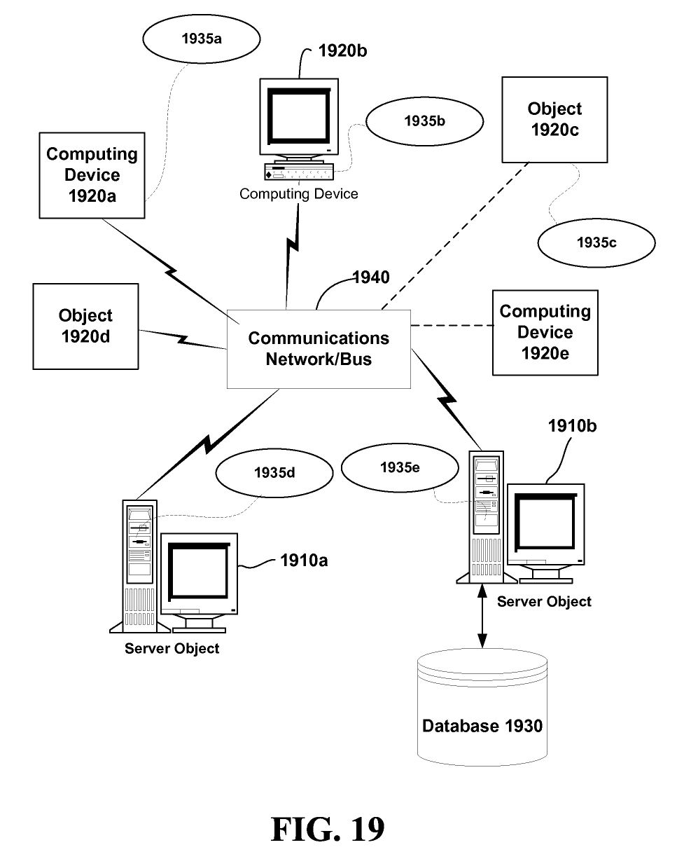

FIG. 1 is an exemplary, non-limiting block diagram generally illustrating a wireless communication environment 100 suitable for incorporation of embodiments of the invention. Wireless communication environment 100 contains a number of nodes 104 operable to communicate with a wireless access component 102 over a wireless communication medium and according to an agreed protocol. As described in further detail below, such nodes and access components typically contain a receiver and transmitter configured to receive and transmit communications signals from and to other nodes or access components. FIG. 1. illustrates that there can be any arbitrary integral number of nodes, and it can be appreciated that due to the mobile nature of such devices and other variables, the subject invention is well-suited for use in such a diverse environment. Optionally, the access component 102 may be accompanied by one or more additional access components and may be connected to other suitable networks and or wireless communication systems as described below with respect to FIGS. 19-21. Additionally, it is contemplated that, for nodes suitably configured to allow such communication, the nodes can communicate wirelessly, between and among nodes in a peer-to-peer fashion.

### T-ALGORITHM

The following discussion provides additional background information regarding the T-Algorithm to facilitate understanding the techniques described herein. The T-algorithm is similar to VA except that the number of the survivor paths is not constant. Unlike the traditional VA which retains all the 2^{K-1} states, only some of the most-likely paths are kept at every trellis stage in the T-algorithm. Accordingly, every surviving path at the trellis stage l-1 is expanded and its successors at stage l are kept if their corresponding path metric values are smaller or equal to dₘ+T, where T is a preset pruning threshold decided by user and dm is the smallest path metric of all the survivor states at stage l-1. However, variations of this general description exist. For example, the number of the states or survivor paths stored can be restricted to a maximum number Nmax set by user, which can be less than 2^{K-1.} Accordingly, among the Nₘₐₓ states, only the states with cumulative path metric satisfying the path threshold restriction are kept.

As a result of using a proper threshold T, significant amount of the paths can be pruned, while maintaining the BER performance. As the corresponding ACS computation for the pruned paths are saved, the computation complexity can be reduced. Advantageously, the choice of the value of T can be varied according to considerations of performance and number of pruned paths.

One aspect of the T-algorithm is a serial comparison operation for searching the best metric in each decoding stage, which limits the T-algorithm's applicability for high throughput applications. For example, in the worst case, there are 2^{K-1} states that require 2^{K-1} comparisons to find the best path metric. For low throughput applications, the comparisons can be done in multiple cycles. As a result, typical architectures for T-algorithms are designed for low throughput applications.

However, in high throughput applications, the fully parallel ACS units are implemented and the ACS computation for each stage is completed in one clock cycle. Thus, the comparison are computed in one cycle, which drastically increases the hardware and power overhead to find the best metric in one cycle, especially when the number of the states is large. One potential solution is to perform the comparison in ν cycles, where ν is the latency of the comparison operation, and where the best path metric is estimated with errors and then is corrected every ν cycles. According to various non-limiting embodiments, the invention provides techniques that eliminate the requirement of finding the best path metric, which advantageously avoids the resultant hardware and power overhead. Rather, various non-limiting embodiments of the invention can approximate the best path metric by using a default best path metrics of an SST decoder.

### SCARCE STATE TRANSITION (SST) DECODING

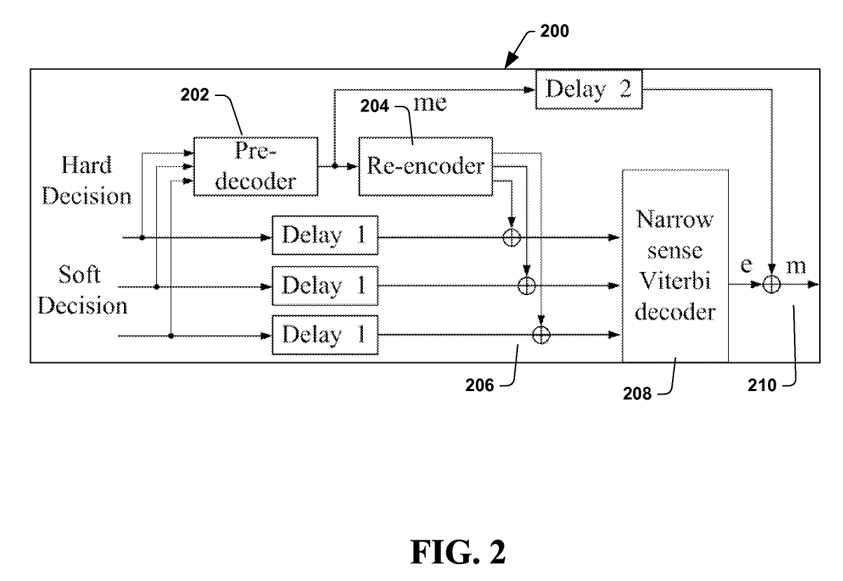

The following discussion provides additional background information regarding SST Decoding Algorithms to facilitate understanding the techniques described herein. FIG. 2 depicts an exemplary non-limiting block diagram of a rate ⅓ SST decoder according to aspects of the invention. SST Viterbi decoder was proposed to minimize the switching activity of the decoded bits and reduce the truncation length. For example, the received data can be first pre-decoded by a simple pre-decoder 202, which performs the inverse of the encoder (not shown). The pre-decoded signal, which contains the information sequence and channel errors, can be re-encoded 204 and XOR'd with the original received data 206 before input to the Viterbi decoder 208. As a result, the input is thus mainly the error of the sequence. Then the Viterbi decoder can be used to correct the errors of the information sequence. At last, the final decoded sequence is obtained by adding the decoded output of the Viterbi decoder with the pre-decoded sequence using modulo-2 addition at 210.

According to some embodiments, the SST decoder can have the following properties: When the channel errors are small, most of decoded output bits of the Viterbi decoder are zero. Thus the switching activity of the SST decoder is much smaller than that of the conventional Viterbi decoder. This is true for most of the practical SNR ranges for a typical communication system. Most of the time the survivor path (e.g., the decoded sequence) will pass through the zero state and the zero state most likely has the smallest path metric. Thus, the probability distribution of the maximum likelihood states is no longer equal to that of the original VA. By taking advantage of this new state probability distribution of the SST decoding, the invention provides a new path pruning scheme to facilitate the implementation of the T-algorithm for high throughput applications, according to various non-limiting embodiments of the invention.

### PATH PRUNING SCHEME BASED ON SST VITERBI DECODER

With the SST scheme, the zero state is most likely to be the best state. Most of the time, the cumulative path metric do of the zero state equals the best path metric dm at high SNR. Thus do can be used instead of dm as the basis for the path pruning. According to various non-limiting embodiments of the invention, the complex sorting or comparing operation to find dm per trellis stage can b e eliminated. Advantageously, there is no overhead in obtaining the estimated best path metric, because the value do can be used from the normal ACS calculation. According to further non-limiting embodiments, the provided techniques can be expressed as described below.

Let s, k represent two states in the trellis diagram, where s is the predecessor state of k. Further, let bmₛ^{k} denote the branch metric of the state transition s to k. The path metric of the state k at stage l can be denoted as dₖ(l) and the path metric of the zero state at stage l-1 cane be denoted as d₀(l-1) . According to embodiments of the invention, when calculating the path metric at stage l, only the paths meet the following threshold condition are kept:

dₖ(l)=dₛ(l-1)+bmₛ^{k}≦d₀(l-1)+T Eqn. 1

According to a further embodiments of the invention, the path metric d₀(l-1) can be used instead of d₀(l) so that the decision to determine whether a path at stage l should be kept or not can be made without waiting for d₀(l) to be computed.

As only the difference between two candidate path metrics will affect the results in the ACS computation, d₀(l-1)+T can be subtracted from all the path metrics such that Eqn. 1 can be expressed as:

dₛ(l-1)+bmₛ^{k}−(d₀(l-1)+T)≦0 Eqn. 2

Letting q=bmₛ^{k}−(d₀(l-1)+T) denote the new branch metric, then Eqn. 2 can be expressed as:

dₛ(l-1)+q≦0 Eqn. 3

where the left hand side of Eqn. 3 is now the new path metric. According to various non-limiting embodiments of the invention, whether this path should be kept or not can be determined by checking the sign of the path metric, instead of comparing it with the threshold in Eqn. 1 like the T-algorithm. The invention advantageously keeps the overhead for the pruning scheme to a minimum using the above transformation, because the number of the branch metrics is usually very small.

Additionally, it can be seen that the predecessor of the zero state is most likely from the zero state also. Thus, d₀(l) most likely equals d₀(l-1)+q=bm₀⁰ −T. If bm₀⁰ is subtracted from all the path metrics, the path metric of the zeros state most likely will be −T, which is a constant and the switching activities of the zero state is reduced. The new branch metric can now be expressed as:

q′=bmₛ^{k}−(d₀(l-1)+T+bm₀⁰) Eqn. 4

According to further embodiments of the invention, Eqn. 4 can be computed by subtracting d₀(l-1)+T+bm₀⁰ from the original branch metric, which can be implemented by modifying the conventional BMU. Advantageously, compared with the conventional structures for T-algorithm, the sorting or comparison units have been eliminated.

It should be noted that the maximum likelihood states may deviate from the zero state. In addition, the number of the survivor paths kept for the proposed scheme can be larger than that of the traditional T-algorithm for the same threshold value T. These conditions can result in a lower saving in ACS reduction. However, according to further embodiments of the invention, different threshold value T can be set in order to save a significant amount of the ACS computation, while the maintaining BER performance of the VA.

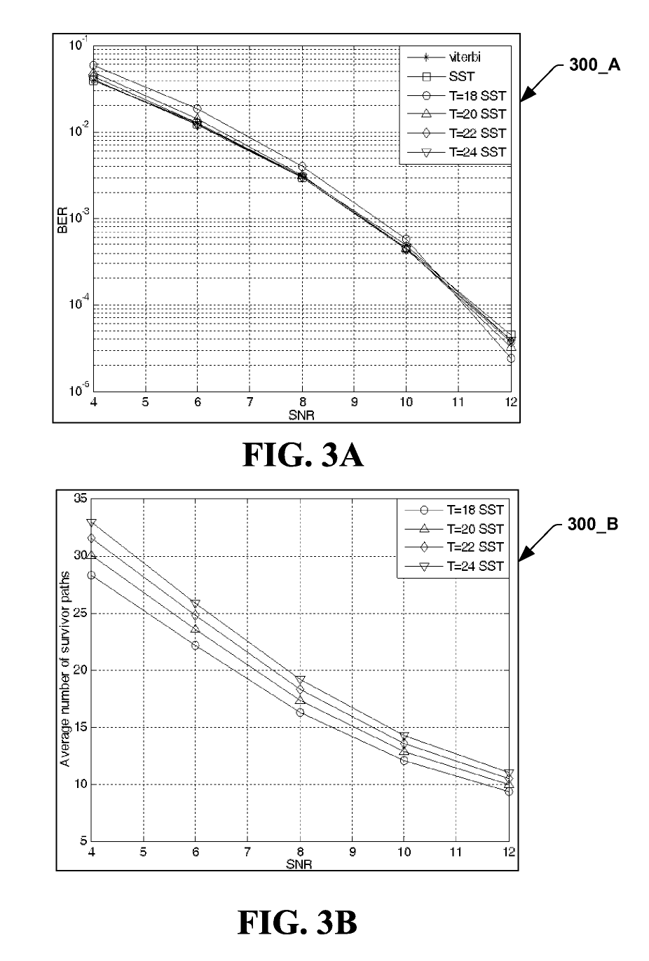

FIGS. 3A and 3B depict the effect of different values of T on the BER performance and computation reduction according to aspects of the invention. The simulation was performed for the transmission mode of the data rate 160 Mbps of the UWB system using the CM1 channel environments. The design SNR for the data rate of 160 Mbps is around 8 dB. FIG. 3A shows that, according to various non-limiting embodiments, the invention can achieve the similar performance of the traditional VA and the original SST, if T≧22. FIG. 3B shows that around 45%˜80% of the paths can be pruned without affecting the performance. For channels with higher SNR values, the decoding schemes of the present invention an increased average number of pruned path.

However, a large reduction in the number of computations does not guarantee significant power saving. Thus, resulting hardware should be designed to transform the reduced computation at the algorithm level to the reduced switching activities in the hardware. According to particular non-limiting embodiments, the invention provides Viterbi decoder techniques for MBOA-OFDM based Ultra-wide-band (UWB) systems suitable for practicing the power reduction techniques of the present invention. The following provides a description of the invention with respect to particular implementations and wherein certain details and parameters are provided for illustration. It is to be appreciated that the provided embodiments are exemplary and non-limiting implementations of the techniques provided by the present invention. As a result, such examples are not intended to limit the scope of the hereto appended claims. For example, certain parameters or combinations thereof are listed for illustration only and are not intended to imply that other parameters or combinations thereof are not possible or desirable. Accordingly, such modifications as would be apparent to one skilled in the are intended to fall within the scope of the hereto appended claims.

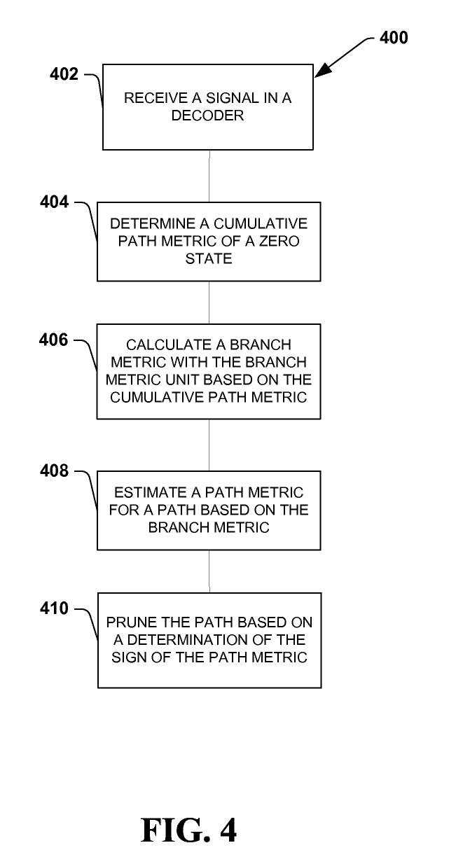

FIG. 4 illustrates one high level methodology according to various aspects of the present invention. The methodology can receive a signal in a decoder at 402. The decoder can be configured to perform a scarce state transition decoding algorithm, and the decoder can comprise a branch metric unit and a plurality of parallel add-compare-select units. At 404, the method determines a cumulative path metric of a zero state in the parallel add-compare-select units, which can be used to calculate a branch metric with the branch metric unit at 406. Next, a path metric can be estimated for a path based on the branch metric according to the scarce state transition decoding algorithm at 408, and can include subtracting a zero state branch metric. The path can be pruned with the decoder based on a determination of the sign of the path metric at 410, where the pruning can result in retaining less than all survivor paths. In a further embodiment, the read operation is performed in a partitioned memory. Additionally, the memory can be partitioned based on a maximum likelihood state probability distribution of a decoder scheme. While for purposes of explanation, the methodology is shown as a series of blocks, it is to be appreciated that the claimed subject matter is not limited by the order of the blocks, as some blocks may occur in different orders and/or concurrently with other blocks from what is depicted. Where non-sequential, or branched, flow is illustrated it is to be appreciated that various other branches, flow paths, and orders of the blocks, may be implemented which achieve the same or a similar result. Moreover, not all illustrated blocks may be required to implement the methodology described hereinafter.

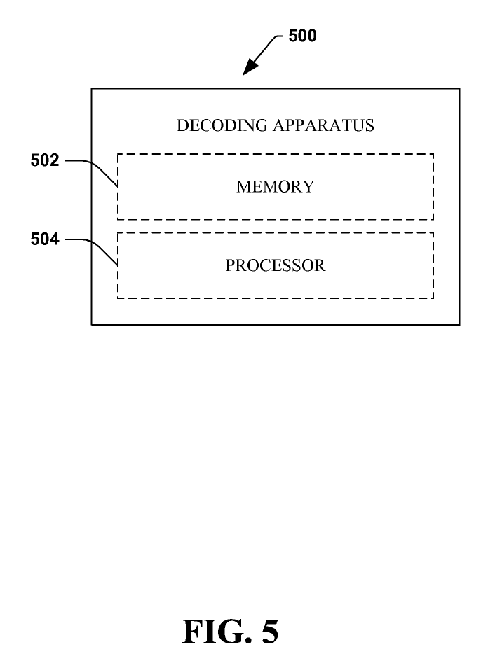

FIG. 5 illustrates an exemplary non-limiting decoding apparatus suitable for performing various techniques of the present invention. The apparatus 500 can be a stand-alone decoding apparatus or portion thereof or a specially programmed computing device or a portion thereof (e.g., a memory retaining instructions for performing the techniques as described herein coupled to a processor). Apparatus 500 can include a memory 502 that retains various instructions with respect to decoding, path pruning, statistical calculations, analytical routines, and/or the like. For instance, apparatus 500 can include a memory 502 that retains instructions for determining a cumulative path metric of a zero state. The memory 502 can further retain instructions for calculating a branch metric based on the cumulative path metric. Additionally, memory 502 can retains instructions for estimating a path metric for a path based on the branch metric, and for pruning the path based on a determination of the sign of the path metric. Memory 502 can further include instructions pertaining to control and operation of a partitioned survivor memory unit. The above example instructions and other suitable instructions can be retained within memory 502, and a processor 504 can be utilized in connection with executing the instructions.

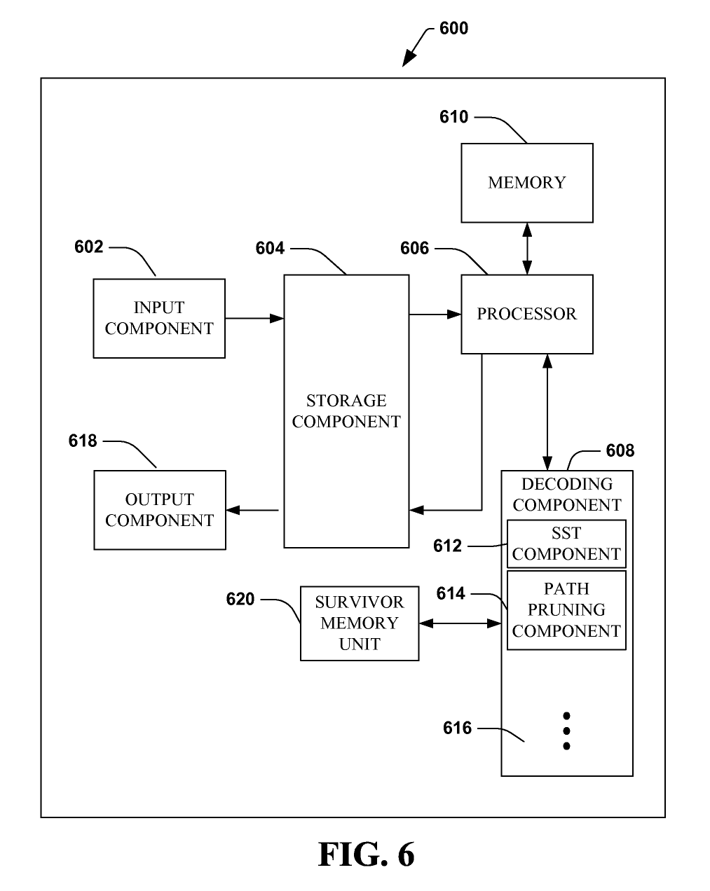

FIG. 6 illustrates a system 600 that can be utilized in connection with the low power viterbi decoder techniques as described herein. System 600 comprises an input component 602 that receives data or signal for decoding, and performs typical actions thereon (e.g., transmits to storage component 604 or other components 608) the received data or signal. A storage component 604 can store the received data or signal for later processing or can provide it to a decoder 608, or a processor 606, via memory 610 over a suitable communications bus or otherwise, or to the output component 618.

Processor 606 can be a processor dedicated to analyzing information received by input component 602 and/or generating information for transmission by an output component 618. Processor 606 can be a processor that controls one or more portions of system 600, and/or a processor that analyzes information received by input component 602, generates information for transmission by output component 618, and performs various decoding algorithms of decoding component 608. System 600 can include a decoding component 608 that can perform the various techniques as described herein, in addition to the various other functions required by the decoding context 620.

Decoding component 608 can include a branch metric unit and a plurality of parallel add-compare-select units as part of scarce state transition component 612. Additionally, Decoding component 608 can be configured to determine a cumulative path metric of a zero state, calculate a branch metric with the branch metric unit based on the cumulative path metric, and estimate a path metric for a path based on the branch metric as described herein. Additionally, decoding component 608 can include a pruning component configured to prune the path based on a determination of the sign of the path metric. While decoding component 608 is shown external to the processor 606 and memory 610, it is to be appreciated that decoding component 608 can include decoding code stored in storage component 604 and subsequently retained in memory 610 for execution by processor 606. The decoding code can utilize artificial intelligence based methods in connection with performing inference and/or probabilistic determinations and/or statistical-based determinations in connection applying the decoding techniques described herein.

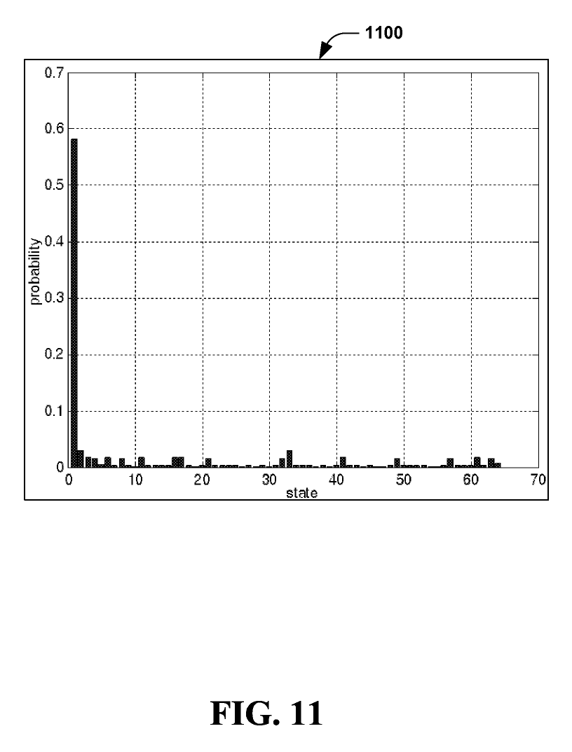

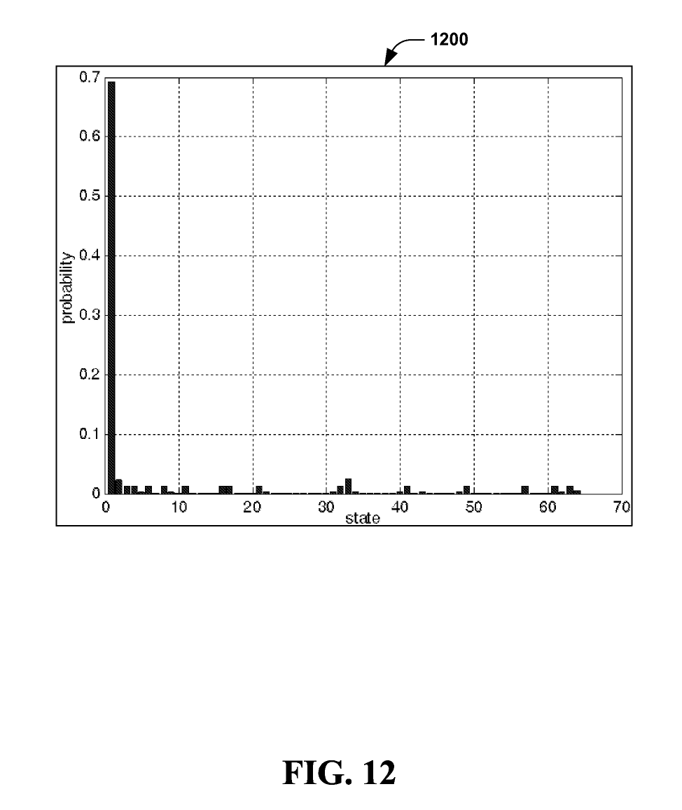

System 600 can additionally comprise memory 610 that is operatively coupled to processor 606 and that stores information such as described above, parameters, information, and the like, wherein such information can be employed in connection with implementing the decoder techniques as described herein. Memory 610 can additionally store protocols associated with generating lookup tables, etc., such that system 600 can employ stored protocols and/or algorithms further to the performance of sequence translation. In addition, system 600 can include a survivor memory unit 620, as described in further detail below in connection with FIGS. 11-15. It will be appreciated that storage component 604, memory 606, and survivor memory unit 620, or any combination thereof as described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 610 is intended to comprise, without being limited to, these and any other suitable types of memory, including processor registers and the like. In addition, by way of illustration and not limitation, storage component 604 can include conventional storage media as in known in the art (e.g., hard disk drive).

### LOW POWER VITERBI DECODER ARCHITECTURE USING SCARCE STATE TRANSITION AND PATH PRUNING

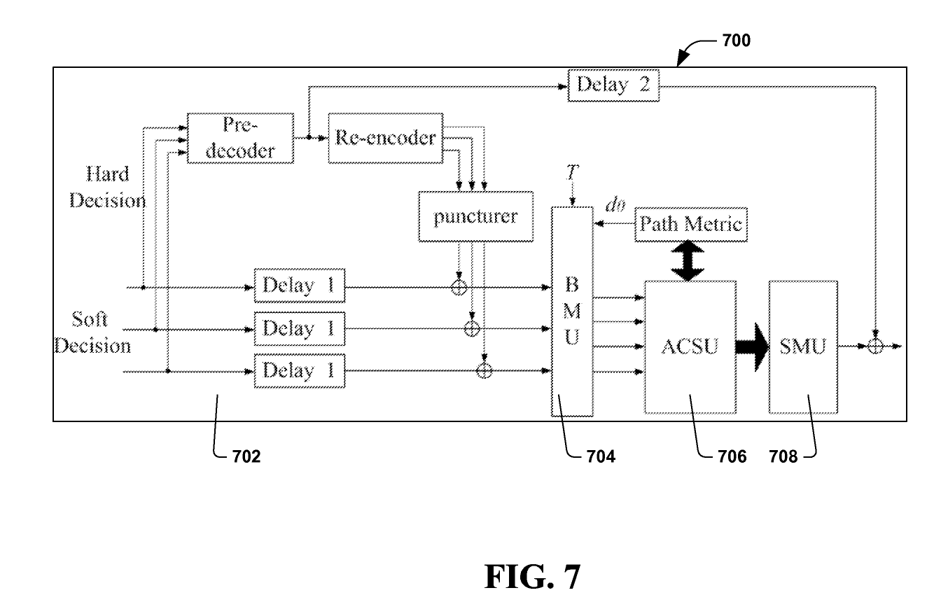

FIG. 7 illustrates an exemplary non-limiting block diagram of a decoder architecture 700 suitable for performing various techniques of the invention. According to particular embodiments, at 702, 5-bit soft metrics can be input to the decoder 700, and the Branch Metric Unit (BMU) 704 can be modified to support the calculation of the new branch metric as described with respect to Eqn. 4. According to further embodiments, the ACSU 706 can contain 64 parallel modified ACS units that support the path pruning and stopping of the ACS calculation when the path is pruned. In addition, Traceback can be used for the SMU 708. The invention can employ the 3-pointer even algorithm that is well-suited for low power consumption. As the zero state is most likely the maximum likelihood state, the traceback operation always begins with the zero state.

### ADD-COMPARE-SELECT (ACS)

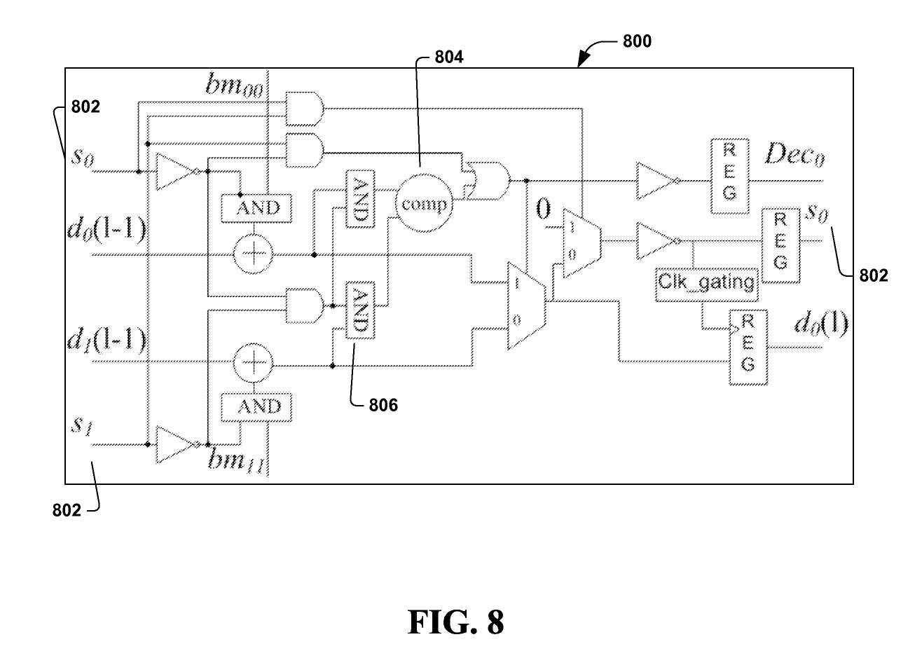

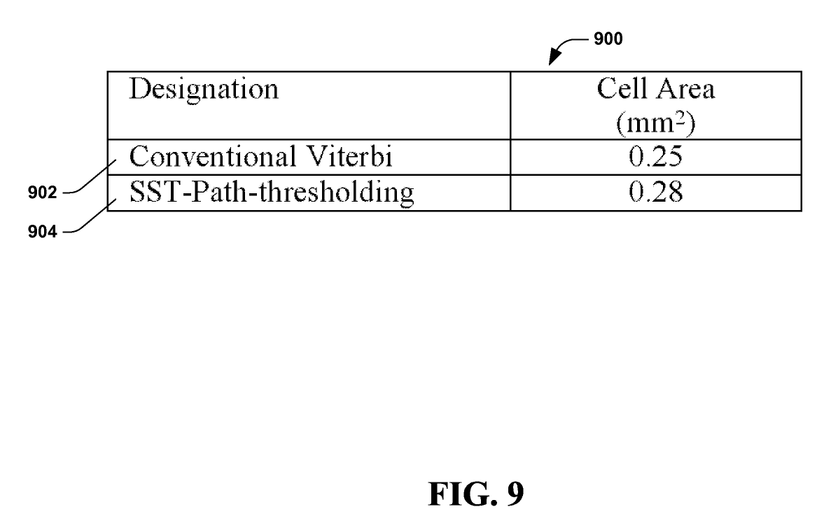

FIG. 8 illustrates an exemplary non-limiting block diagram of a structure for an ACS unit 800 in the ACSU as illustrated in FIG. 7 suitable for performing various techniques of the invention. An additional signal S can be used to indicate whether the path is pruned or not, according to an aspect of the invention. S can be determined by the sign (e.g., MSB) of the calculated path metric d₀(l) as described supra. S can also be used to gate the path metric register to reduce the switching activity of the ACS if the path is pruned. Additionally, it can be used to mask the input to the adder and the comparator 804 of the ACS if the path is pruned. According to particular embodiments, the branch metric cannot just be gated as it is used in conventional ACS units. In addition, the whole ACS unit cannot be completely disabled as there can be cases that only one path is pruned while the other path is active. However, an S signal can be advantageously used together with an AND gate 806 to mask the input signals to the adders and the comparator 804 to reduce the switching activity, instead of using complicated clock gating control. For the pruned paths, most of the time the input to the adder and the comparator will be zero and there is not switching activity. Additionally, an S signal to the AND gate can be ensured to always be the earliest input to eliminate glitches. FIG. 9 tabulates cell area for a conventional ACSU 902 and a particular non-limiting embodiment of an ACSU according to techniques of the present invention for a 0.18 μm Complementary Metal-Oxide-Semiconductor (CMOS) process. As can be seen from FIG. 9 the area overhead for the additional hardware is minimal.

### SURVIVOR MEMORY UNIT (SMU)

A 3-pointer even algorithm can be used in the implementation of a SMU, according to particular non-limiting embodiments of the invention. However, the large number of memory accesses during the traceback and decoding stage and the wide memory word width can lead to large power consumption in the SMU. In general, in order to generate the decoded output at the required truncation length L, more read operations are required than write operations in the TB. For example, for a 3-pointer even algorithm using 6 banks of memories, one write and three read access of the memory of 64 bits wide are required to decode a single bit.

Accordingly, the invention advantageously reduces the power consumption of the SMU by reducing the power consumption for the read operation. For example, in the traceback read operation, it is inefficient to read all the 64 decision bits at each stage. As a result the invention can read out the required bit and not access the other bits, according to various non-limiting embodiments. As a result, the power consumption for the read operation can be greatly reduced. However, in order to achieve such a result, further non-limiting embodiments of the invention provides techniques facilitating memory partitioning into many smaller units that can be addressed and enabled separately.

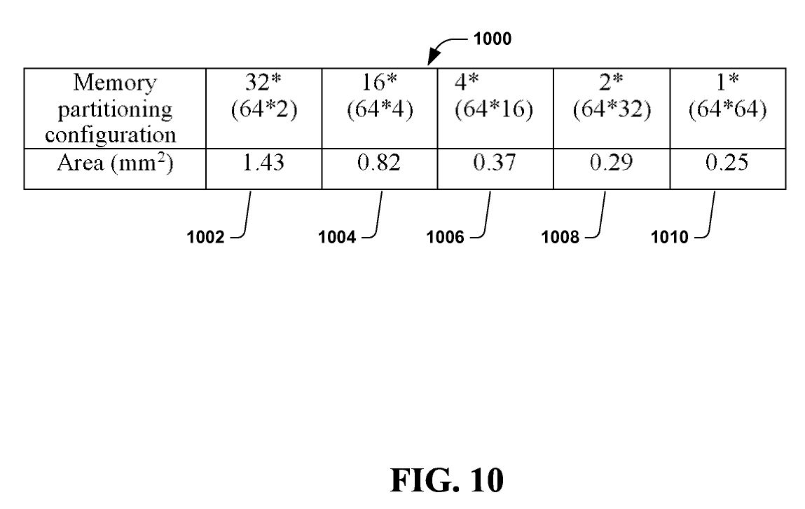

FIG. 10 tabulates cell area for various non-limiting embedded memory partition configurations with different bit width for a 64×64 memory unit generated by Artisan memory generator for a 0.18 μm CMOS process, where the entries are given as Number* (Number of Entry*bitwidth). It can be seen that having large number of small memory partitions to facilitate the low power consumption can have significant area overhead. For example, the area is increased by almost five times if the memory is partitioned 1002 into 32 blocks of 2-bit wide memory. Accordingly, the invention provides a wide range of possible area and power reduction design trade-off according to system design considerations. However, a low power design should have a small number of partitions and at the same time reduce the power of the read access.

As a result, according to various non-limiting embodiments, the invention provides an uneven-partitioned memory architecture for the SMU based on the maximum likelihood state probability distribution of the SST scheme. In SST decoding, the Viterbi decoder can be used to decode the errors of the information sequence. When the channel errors are small, the decoded bits are most likely to be zero. Thus the maximum likelihood state is the zero state is most of the time, while for conventional VA, the maximum likelihood state is evenly distributed across all states. Therefore the probabilities of the states being the maximum likelihood state are no longer equal to that of the conventional VA.

FIGS. 10-11 depict distribution probability of maximum likelihood states for the 64 states at SNR=8 dB and SNR=10 dB, respectively, for an exemplary non-limiting UWB system, obtained for a data rate of 160 Mbps with the CM1 channel environments. The zero state has highest probability to be the maximum likelihood state, and as SNR increases, the channel errors are fewer and the probability of the zero state increases. FIGS. 10-11 illustrate that besides the zero states, the probabilities of the other states are also not evenly distributed. For example, there are groups of states that have higher probabilities and are more directly reachable from the zero state (e.g., state 32) or directly transit to the zero state (e.g., state l). One observation arising from the uneven probability distribution is that path of the decoded sequence most likely passes through the states with high probability. Therefore the decision bits of the states with higher probability are more likely to be read.

Based on this uneven state probability distribution, the invention provides an uneven-partitioned memory architecture for the SMU, according to various non-limiting embodiments. The technique can store the decision bits of the states with higher probability into memory with smaller bit-width and the decision bits of the states with lower probability into another memory with large bit-width. Advantageously, resulting read operations can access the smaller memory most of the time and the overall power consumption of the read operation can be reduced compared with that of reading all the 64 bits out in every cycle. In addition, the number of the partitioned memory should be small in order to reduce the area overhead.

It is to be appreciated that the provided embodiments are exemplary and non-limiting implementations of the techniques provided by the present invention. As a result, such examples are not intended to limit the scope of the hereto appended claims. For example, certain memory configurations or design-tradeoffs are listed for illustration only and are not intended to imply that other parameters or combinations thereof are not possible or desirable. Accordingly, such modifications as would be apparent to one skilled in the are intended to fall within the scope of the hereto appended claims.

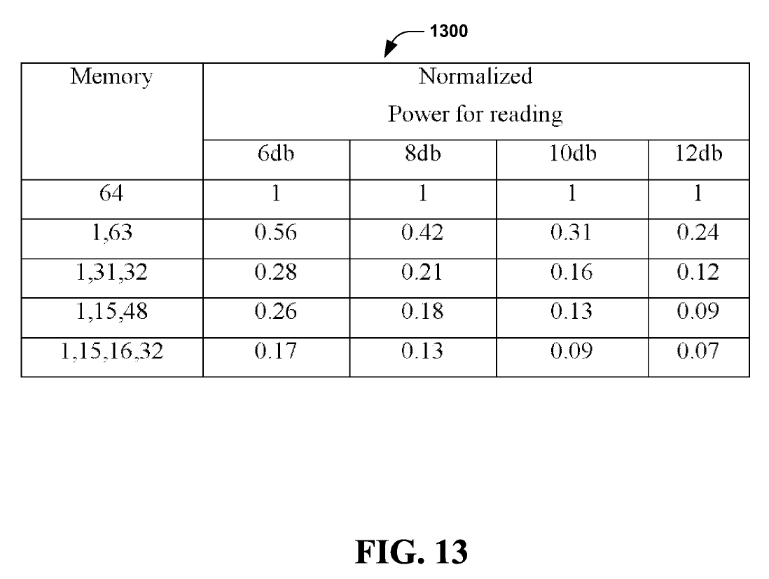

FIG. 13 tabulates estimated power consumption of the traceback read operation for various non-limiting partitioning configurations, assuming power consumption of the read access is proportional to bit-width of the memory.

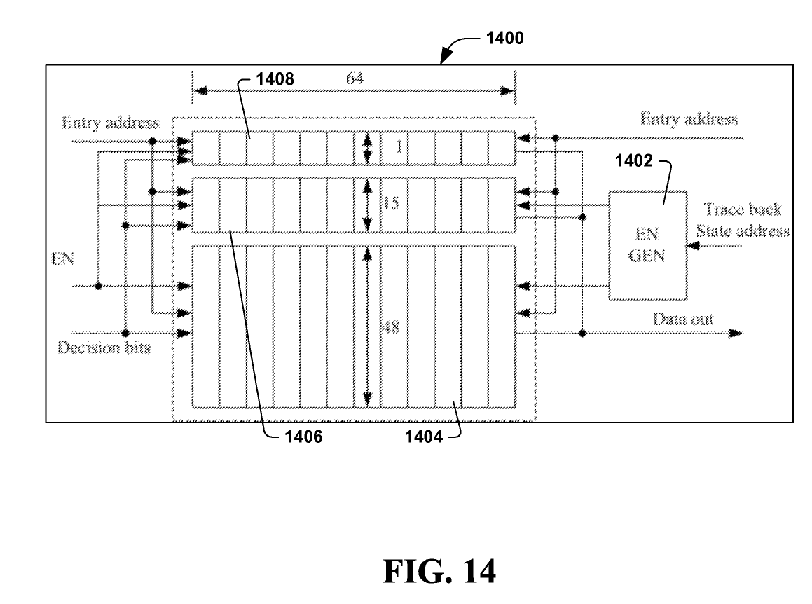

FIG. 14 illustrates an exemplary non-limiting block diagram of a memory unit suitable for performing various techniques of the invention. The memory unit can include a memory enable signal generator 1402 that can be used to enable the read access of the two embedded SRAMs 1404, 1406. In one embodiment, a configuration 1400 of 1, 15, 48 can be used as a possible design trade-off between area and power reduction. For example, a one bit memory partition 1408 can be used to store the decision bits of the zero state and can be implemented in registers instead of embedded SRAM 1404,1406. As a further example, a 15-bit memory 1406 can be used to store the decision bits of the fifteen states with the next highest probabilities besides the zero state.

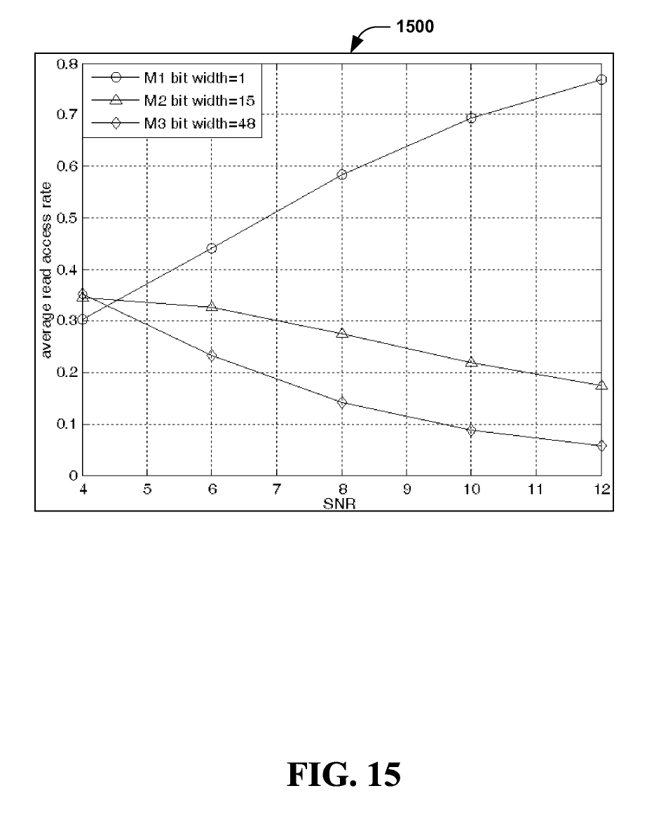

FIG. 15 depicts average read access rate of the different memories of FIG. 14 with an UWB system data rate of 160 Mbps under various SNRs, according to various aspects of the invention. It can be seen that most the time, the memory for the zero state is read and the corresponding access rate increases as the SNR increases. For the low SNR range, significant amount of power can still be saved. The total access rate for the 15-bit memory and 48-bit memory pair is up to 60%.

### EXPERIMENTAL RESULTS

As described above, a particular embodiment of a Viterbi decoder targeting MBOA-OFDM UWB applications can be implemented in SMIC 0.18 μm CMOS process. Simulation results show that significant power consumption reduction can be achieved for high throughput wireless systems such as MB-OFDM Ultra-wide-band applications. Experimental results indicate that both the power of the ACSU and the SMU are reduced significantly compared with conventional Viterbi decoders.

For the UWB system, a convolutional code with constraint length 7 was used. The generator polynomials are 133₈, 165₈ and 171₈, respectively. Performance of the system was simulated using the CM1 channel environment with 100 channel realizations. The received symbols were quantized to 5-bit soft metric. The Viterbi decoders of the VA, SST and the SST-path thresholding scheme were implemented in VHDL and then synthesized with Synopsys (Design Compiler) using the Artisan's SMIC 0.18 μm standard cell library. The embedded SRAM is generated by the Artisan's memory generator, and the power consumption was simulated using synopsys VCS-MX and power compiler. One frame of the data generated by the UWB system under different SNRs was used to simulate the power consumption with a supply voltage is 1.8V and clock frequency of 200 MHz.

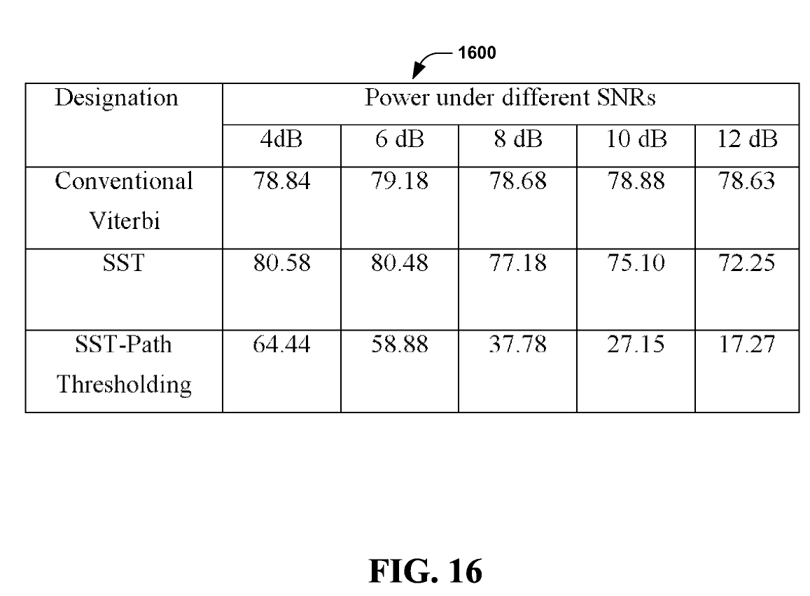

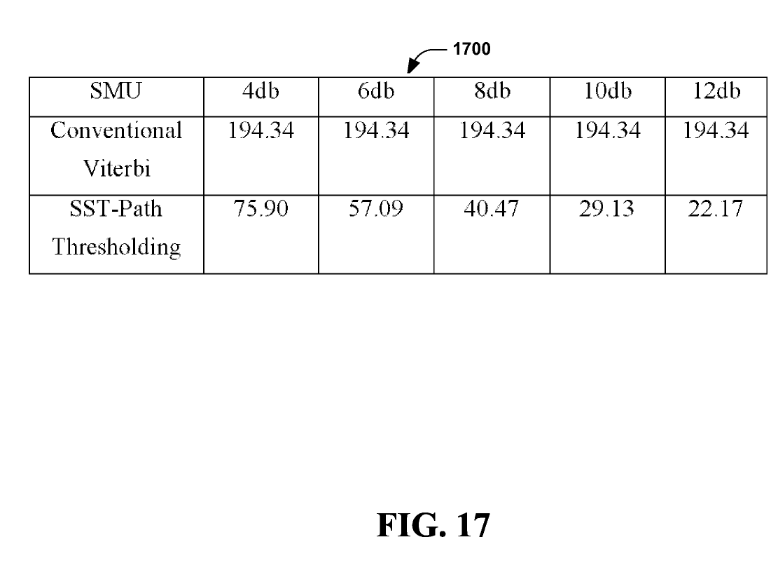

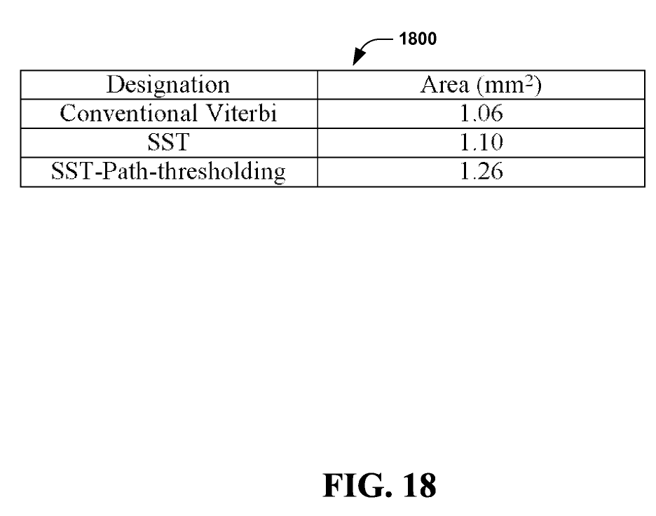

FIGS. 16-17 summarize the power consumption of different parts of the Viterbi decoder. FIG. 16 depicts power consumption performance the power of computational parts (e.g., Branch Metric Unit (BMU), Add-Compare-Select Unit (ACSU) and the additional logic for Scarce State Transition (SST) decoding) of a particular nonlimiting embodiment of a decoder according to various aspects of the present invention. FIG. 17 depicts power consumption performance of Trace Back (TB) and decoding Survivor Memory Unit (SMU) of a particular nonlimiting embodiment of a decoder according to various aspects of the present invention. From FIG. 16, it can be seen that 30%˜76% reduction in power consumption can be obtained for the computational parts over the traditional design for different SNR values. For the read access during TB and decoding, the power consumption can be reduced by as much as 80% when uneven-partitioned memory is used. FIG. 18 depicts an overall cell area comparison of different decoding schemes for a particular nonlimiting embodiment of the invention. With a small area overhead, the power consumption of a high-throughput parallel Viterbi decoder can be reduced significantly.

### EXEMPLARY COMPUTER NETWORKS AND ENVIRONMENTS

One of ordinary skill in the art can appreciate that the invention can be implemented in connection with any computer or other client or server device, which can be deployed as part of a communications system, a computer network, or in a distributed computing environment, connected to any kind of data store. In this regard, the present invention pertains to any computer system or environment having any number of memory or storage units, and any number of applications and processes occurring across any number of storage units or volumes, which may be used in connection with communication systems using the decoder techniques, systems, and methods in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the communication systems using the decoder techniques, systems, and methods of the invention.

FIG. 19 provides a schematic diagram of an exemplary networked or distributed computing environment. The distributed computing environment comprises computing objects 1910a, 1910b, etc. and computing objects or devices 1920a, 1920b, 1920c, 1920d, 1920e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1940. This network may itself comprise other computing objects and computing devices that provide services to the system of FIG. 19, and may itself represent multiple interconnected networks. In accordance with an aspect of the invention, each object 1910a, 1910b, etc. or 1920a, 1920b, 1920c, 1920d, 1920e, etc. may contain an application that might make use of an API, or other object, software, firmware and/or hardware, suitable for use with the design framework in accordance with the invention.

It can also be appreciated that an object, such as 1920c, may be hosted on another computing device 1910a, 1910b, etc. or 1920a, 1920b, 1920c, 1920d, 1920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for communicating information used in the communication systems using the decoder techniques, systems, and methods according to the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 19, as an example, computers 1920a, 1920b, 1920c, 1920d, 1920e, etc. can be thought of as clients and computers 1910a, 1910b, etc. can be thought of as servers where servers 1910a, 1910b, etc. maintain the data that is then replicated to client computers 1920a, 1920b, 1920c, 1920d, 1920e, etc., although any computer can be considered a client, a server, or both, depending on the circumstances. Any of these computing devices may be processing data or requesting services or tasks that may use or implicate the communication systems using the decoder techniques, systems, and methods in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to communication (wired or wirelessly) using the decoder techniques, systems, and methods of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 19 illustrates an exemplary networked or distributed environment, with server(s) in communication with client computer(s) via a network/bus, in which the present invention may be employed. In more detail, a number of servers 1910a, 1910b, etc. are interconnected via a communications network/bus 1940, which may be a LAN, WAN, intranet, GSM network, the Internet, etc., with a number of client or remote computing devices 1920a, 1920b, 1920c, 1920d, 1920e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to communicate data over a network.

In a network environment in which the communications network/bus 1940 is the Internet, for example, the servers 1910a, 1910b, etc. can be Web servers with which the clients 1920a, 1920b, 1920c, 1920d, 1920e, etc. communicate via any of a number of known protocols such as HTTP. Servers 1910a, 1910b, etc. may also serve as clients 1920a, 1920b, 1920c, 1920d, 1920e, etc., as may be characteristic of a distributed computing environment.

As mentioned, communications to or from the systems incorporating the decoder techniques, systems, and methods of the present invention may ultimately pass through various media, either wired or wireless, or a combination, where appropriate. Client devices 1920a, 1920b, 1920c, 1920d, 1920e, etc. may or may not communicate via communications network/bus 19, and may have independent communications associated therewith. For example, in the case of a TV or VCR, there may or may not be a networked aspect to the control thereof. Each client computer 1920a, 1920b, 1920c, 1920d, 1920e, etc. and server computer 1910a, 1910b, etc. may be equipped with various application program modules or objects 1935a, 1935b, 1935c, etc. and with connections or access to various types of storage elements or objects, across which files or data streams may be stored or to which portion(s) of files or data streams may be downloaded, transmitted or migrated. Any one or more of computers 1910a, 1910b, 1920a, 1920b, 1920c, 1920d, 1920e, etc. may be responsible for the maintenance and updating of a database 1930 or other storage element, such as a database or memory 1930 for storing data processed or saved based on communications made according to the invention. Thus, the present invention can be utilized in a computer network environment having client computers 1920a, 1920b, 1920c, 1920d, 1920e, etc. that can access and interact with a computer network/bus 1940 and server computers 1910a, 1910b, etc. that may interact with client computers 1920a, 1920b, 1920c, 1920d, 1920e, etc. and other like devices, and databases 1930.

### EXEMPLARY COMPUTING DEVICE

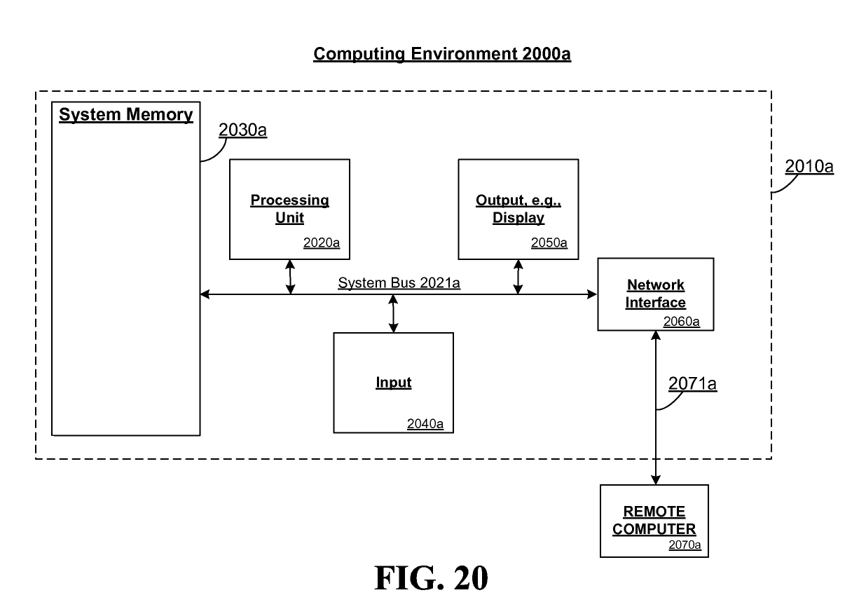

As mentioned, the invention applies to any device wherein it may be desirable to communicate data, e.g., to or from a mobile device. It should be understood, therefore, that handheld, portable and other computing devices and computing objects of all kinds are contemplated for use in connection with the present invention, i.e., anywhere that a device may communicate data or otherwise receive, process or store data. Accordingly, the below general purpose remote computer described below in FIG. 20 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the some aspects of the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 20 thus illustrates an example of a suitable computing system environment 2000a in which some aspects of the invention may be implemented, although as made clear above, the computing system environment 2000a is only one example of a suitable computing environment for a media device and is not intended to suggest any limitation as to the scope of use or functionality of the invention. Neither should the computing environment 2000a be interpreted as having any dependency or requirement relating to any one or combination of components illustrated in the exemplary operating environment 2000a.

With reference to FIG. 20, an exemplary remote device for implementing the invention includes a general purpose computing device in the form of a computer 2010a. Components of computer 2010a may include, but are not limited to, a processing unit 2020a, a system memory 2030a, and a system bus 2021a that couples various system components including the system memory to the processing unit 2020a. The system bus 2021a may be any of several types of bus structures including a memory bus or memory controller, a peripheral bus, and a local bus using any of a variety of bus architectures.

Computer 2010a typically includes a variety of computer readable media. Computer readable media can be any available media that can be accessed by computer 2010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 2010a. Communication media typically embodies computer readable instructions, data structures, program modules or other data in a modulated data signal such as a carrier wave or other transport mechanism and includes any information delivery media.

The system memory 2030a may include computer storage media in the form of volatile and/or nonvolatile memory such as read only memory (ROM) and/or random access memory (RAM). A basic input/output system (BIOS), containing the basic routines that help to transfer information between elements within computer 2010a, such as during start-up, may be stored in memory 2030a. Memory 2030a typically also contains data and/or program modules that are immediately accessible to and/or presently being operated on by processing unit 2020a. By way of example, and not limitation, memory 2030a may also include an operating system, application programs, other program modules, and program data.

The computer 2010a may also include other removable/non-removable, volatile/nonvolatile computer storage media. For example, computer 2010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 2021a through a non-removable memory interface such as an interface, and a magnetic disk drive or optical disk drive is typically connected to the system bus 2021a by a removable memory interface, such as an interface.

A user may enter commands and information into the computer 2010a through input devices such as a keyboard and pointing device, commonly referred to as a mouse, trackball or touch pad. Other input devices may include a microphone, joystick, game pad, satellite dish, scanner, wireless device keypad, voice commands, or the like. These and other input devices are often connected to the processing unit 2020a through user input 2040a and associated interface(s) that are coupled to the system bus 2021a, but may be connected by other interface and bus structures, such as a parallel port, game port or a universal serial bus (USB). A graphics subsystem may also be connected to the system bus 2021a. A monitor or other type of display device is also connected to the system bus 2021a via an interface, such as output interface 2050a, which may in turn communicate with video memory. In addition to a monitor, computers may also include other peripheral output devices such as speakers and a printer, which may be connected through output interface 2050a.

The computer 2010a may operate in a networked or distributed environment using logical connections to one or more other remote computers, such as remote computer 2070a, which may in turn have media capabilities different from device 2010a. The remote computer 2070a may be a personal computer, a server, a router, a network PC, a peer device, personal digital assistant (PDA), cell phone, handheld computing device, or other common network node, or any other remote media consumption or transmission device, and may include any or all of the elements described above relative to the computer 2010a. The logical connections depicted in FIG. 20 include a network 2071a, such local area network (LAN) or a wide area network (WAN), but may also include other networks/buses, either wired or wireless. Such networking environments are commonplace in homes, offices, enterprise-wide computer networks, intranets and the Internet.

When used in a LAN networking environment, the computer 2010a is connected to the LAN 2071a through a network interface or adapter. When used in a WAN networking environment, the computer 2010a typically includes a communications component, such as a modem, or other means for establishing communications over the WAN, such as the Internet. A communications component, such as a modem, which may be internal or external, may be connected to the system bus 2021a via the user input interface of input 2040a, or other appropriate mechanism. In a networked environment, program modules depicted relative to the computer 2010a, or portions thereof, may be stored in a remote memory storage device. It will be appreciated that the network connections shown and described are exemplary and other means of establishing a communications link between the computers may be used.

While the present invention has been described in connection with the preferred embodiments of the various figures, it is to be understood that other similar embodiments may be used or modifications and additions may be made to the described embodiment for performing the same function of the present invention without deviating therefrom. For example, one skilled in the art will recognize that the present invention as described in the present application applies to communication systems using the disclosed decoder techniques, systems, and methods and may be applied to any number of devices connected via a communications network and interacting across the network, either wired, wirelessly, or a combination thereof. In addition, it is understood that in various network configurations, access points may act as nodes and nodes may act as access points for some purposes.

Accordingly, while words such as transmitted and received are used in reference to the described communications processes; it should be understood that such transmitting and receiving is not limited to digital communications systems, but could encompass any manner of sending and receiving data suitable for processing by the described decoding techniques. For example, the data subject to the decoder techniques may be sent and received over any type of communications bus or medium capable of carrying the subject data from any source capable of transmitting such data. As a result, the present invention should not be limited to any single embodiment, but rather should be construed in breadth and scope in accordance with the appended claims.

### EXEMPLARY COMMUNICATIONS NETWORKS AND ENVIRONMENTS

The above-described communication systems using the decoder techniques, systems, and methods may be applied to any network, however, the following description sets forth some exemplary telephony radio networks and non-limiting operating environments for communications made incident to the communication systems using the decoder techniques, systems, and methods of the present invention. The below-described operating environments should be considered non-exhaustive, however, and thus the below-described network architecture merely shows one network architecture into which the present invention may be incorporated. One can appreciate, however, that the invention may be incorporated into any now existing or future alternative architectures for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1× Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the decoder techniques, systems, and methods of the present invention may be applied independently of the method of data transport, and does not depend on any particular network architecture, or underlying protocols.

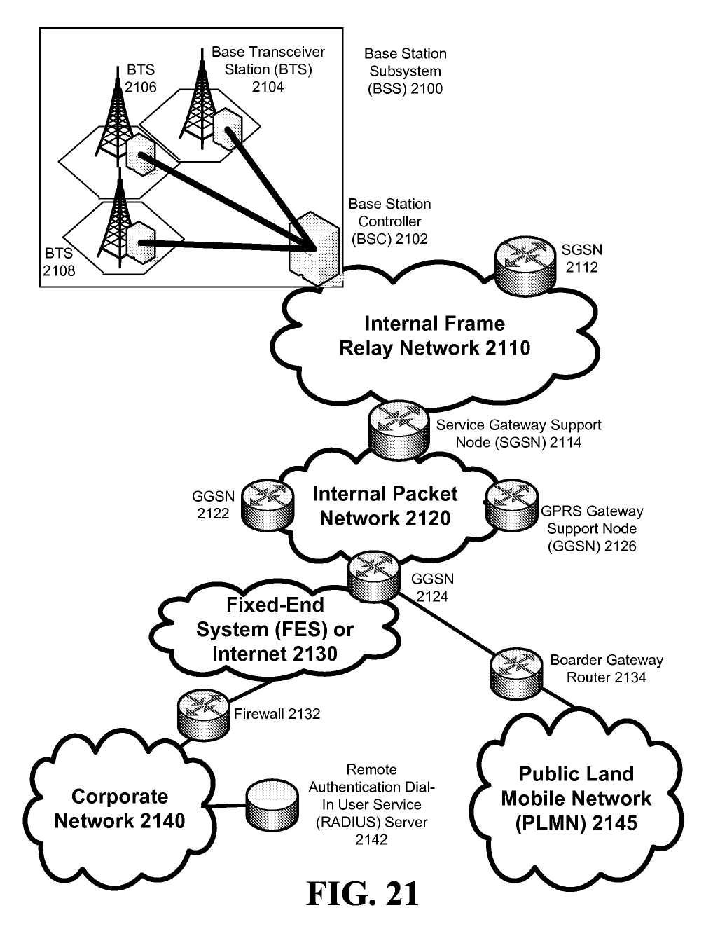

FIG. 21 depicts an overall block diagram of an exemplary packet-based mobile cellular network environment, such as a GPRS network, in which the invention may be practiced. In such an environment, there are a plurality of Base Station Subsystems (“BSS”) 2100 (only one is shown), each of which comprises a Base Station Controller (“BSC”) 2102 serving a plurality of Base Transceiver Stations (“BTS”) such as BTSs 2104, 2106, and 2108. BTSs 2104, 2106, 2108, etc. are the access points where users of packet-based mobile devices become connected to the wireless network. In exemplary fashion, the packet traffic originating from user devices is transported over the air interface to a BTS 2108, and from the BTS 2108 to the BSC 2102. Base station subsystems, such as BSS 2100, are a part of internal frame relay network 2110 that may include Service GPRS Support Nodes (“SGSN”) such as SGSN 2112 and 2114. Each SGSN is in turn connected to an internal packet network 2120 through which a SGSN 2112, 2114, etc. can route data packets to and from a plurality of gateway GPRS support nodes (GGSN) 2122, 2124, 2126, etc. As illustrated, SGSN 2114 and GGSNs 2122, 2124, and 2126 are part of internal packet network 2120. Gateway GPRS serving nodes 2122, 2124 and 2126 mainly provide an interface to external Internet Protocol (“IP”) networks such as Public Land Mobile Network (“PLMN”) 2145, corporate intranets 2140, or Fixed-End System (“FES”) or the public Internet 2130. As illustrated, subscriber corporate network 2140 may be connected to GGSN 2124 via firewall 2132; and PLMN 2145 is connected to GGSN 2124 via boarder gateway router 2134. The Remote Authentication Dial-In User Service (“RADIUS”) server 2142 may be used for caller authentication when a user of a mobile cellular device calls corporate network 2140.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. Furthermore, aspects may be fully integrated into a single component, be assembled from discrete devices, or implemented as a combination suitable to the particular application and is a matter of design choice. As used herein, the terms “node,” “access point,” “component,” “system,” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the systems of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g. compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

While for purposes of simplicity of explanation, methodologies disclosed herein are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the particular embodiments of the various figures, it is to be understood that other similar embodiments may be used or modifications and additions may be made to the described embodiment for performing the same function of the present invention without deviating therefrom. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for low power signal decoding comprising:
receiving a signal in a decoder, the decoder configured to perform a scarce state transition decoding algorithm and comprising a branch metric unit and a plurality of parallel add-compare-select units;
determining a cumulative path metric of a zero state in the plurality of parallel add-compare-select units;
calculating a branch metric with the branch metric unit based on the cumulative path metric;
estimating a path metric for a path based on the branch metric according to the scarce state transition decoding algorithm; and
pruning the path with the decoder based on a determination of the sign of the path metric.

2. The method of claim 1, wherein the pruning includes pruning resulting in retaining less than all survivor paths.

3. The method of claim 1, wherein the estimating a path metric includes subtracting a zero state branch metric.

4. The method of claim 1, further comprising performing a traceback read operation in a memory, wherein less than all decision bits at a stage are read, to reduce traceback read operation power consumption.

5. The method of claim 4, the performing includes performing the traceback read operation in a partitioned memory.

6. The method of claim 5, wherein the partitioned memory includes an uneven partitioned memory.

7. The method of claim 6, wherein the uneven partitioned memory is partitioned based at least upon a maximum likelihood state probability distribution of the decoder.

8. A computer readable medium comprising computer executable instructions for performing the method of claim 1.

9. A decoding apparatus comprising means for performing the method of claim 1.

10. A system for signal decoding comprising:
an input component configured to receive a signal for decoding;
a decoder component including a branch metric unit and a plurality of parallel add-compare-select units wherein the decoder component is configured to determine a cumulative path metric of a zero state, calculate a branch metric with the branch metric unit based on the cumulative path metric, and estimate a path metric for a path based on the branch metric; and
pruning component configured to prune the path based on a determination of the sign of the path metric;

11. The system of claim 10, wherein the pruning component is further configured to retain less than all survivor paths.

12. The system of claim 10, further comprising a survivor memory unit configured to perform a traceback read operation in a memory where less than all decision bits at a stage are read.

13. The system of claim 12, the memory is a partitioned memory.

14. The system of claim 13, the partitioned memory is unevenly partitioned.

15. The system of claim 13, the partitioned memory is configured according to a partitioning scheme.

16. The system of claim 15, the partitioning scheme is based upon a maximum likelihood state probability distribution of the decoding component.

17. A low power decoding apparatus, comprising:
a memory that retains instructions for determining a cumulative path metric of a zero state, for calculating a branch metric based on the cumulative path metric, for estimating a path metric for a path based on the branch metric, and for pruning the path based on a determination of the sign of the path metric; and
a processor that is configured to execute the instructions within the memory.

18. The communications apparatus of claim 17, further comprising a survivor memory unit configured to perform a traceback read operation in a partitioned memory where less than all decision bits at a decoding stage are read.

19. The communications apparatus of claim 18, the partitioned memory is configured according to a partitioning scheme.

20. The communications apparatus of claim 19, the partitioning scheme is based upon a maximum likelihood state probability distribution of the scarce state transition decoding.
